(19) United States
(12) Patent Application Publication
(10) Pub. No.: US 2012/0089614 A1
(43) Pub. Date: Apr. 12, 2012

(54) Computer-Implemented Systems And Methods For Matching Records Using Matchcodes With Scores

(76) Inventor: Jocelyn Siu Luan Hamilton, Mebane, NC (US)

(21) Appl. No.: 13/220,945

(22) Filed: Aug. 30, 2011

Related U.S. Application Data
(63) Continuation-in-part of application No. 12/900,640, filed on Oct. 8, 2010.

(51) Int. Cl. G06F 17/30

(52) U.S. Cl. 707/748; 707/E17.084

(57) ABSTRACT

Systems and methods are provided for generating matchcode scores for a record. In one example, a record is received that includes one or more fields, each field having an associated field type. One or more alternative forms of the record are generated based on variations of the one or more fields of the record. A frequency score is identifying, from stored frequency information, for each variation of the one or more fields of the record, wherein each frequency score relates to a frequency of use for a text string included in a field. Using the frequency scores, overall scores are generated for the record and the one or more alternative forms of the record.

### CROSS-REFERENCE TO RELATED APPLICATION

This application is a continuation-in-part of U.S. patent application Ser. No. 12/900,640, titled Computer-Implemented Systems and Methods for Matching Recordings Using Matchcodes with Scores,” filed on Oct. 8, 2010, the entirety of which is incorporated herein by reference.

### TECHNICAL FIELD

The present disclosure relates generally to computer-implemented systems and methods for matching records.

### BACKGROUND

A record may include data of personal names, dates, addresses and other information. Record matching is the process of bringing together two or more different records which may refer to the same real-world object. Record matching is useful in statistical surveys, administrative data development and many other areas. It is important to develop effective and efficient techniques for record matching. As humans can account for transpositions, typographical errors, abbreviations, missing data and other input errors in record matching, computer-implemented systems and methods for matching records can achieve results at least as good as a highly trained clerk.

### SUMMARY

As disclosed herein, computer-implemented systems and methods are provided for generating matchcode scores for a record. In one example, a record that includes a plurality of fields is received. One or more token combination rules are applied to the record to associate one or more tokens with each of the plurality of fields, wherein each of the one or more tokens includes a text string from one of the plurality of fields of the record. A spellcheck application is applied to each of the tokens to generate one or more alternative tokens for each of the plurality of fields of the record. A score is generated for each token and alternative token in each of the plurality of fields, wherein the score is based at least in part on a frequency score, and wherein each frequency score relates to a frequency of use for the text string included in the token. A plurality of token combinations are generated from the tokens and alternative tokens based on the one or more token combination rules, wherein each of the plurality of token combinations includes one token or alternative token from each of the plurality of fields of the record. An overall score is generated for each token combination based at least in part on the scores for the tokens or alternative tokens that make up the token combination.

In another example, a record is received that includes one or more fields, each field having an associated field type. One or more alternative forms of the record are generated based on variations of the one or more fields of the record. A frequency score is identified, from stored frequency information, for each variation of the one or more fields of the record, wherein each frequency score relates to a frequency of use for a text string included in a field. Using the frequency scores, overall scores are generated for the record and the one or more alternative forms of the record.

In yet another example, a record is received that is parsed into a plurality of tokens, each token having an associated token type. Spelling variants are identified for each of the plurality of tokens. A plurality of alternative tokens are identified using the spelling variants and variations of the associated token type. A frequency score is identified, from stored frequency information, for each of the plurality of tokens and each of the plurality of alternative tokens, wherein each frequency score relates to a frequency of use for a text string included in the token or alternative token. One or more alternative records are identified using one or more combinations of the plurality of alternative tokens. Overall scores are generated for the record and the one or more alternative records based at least in part on the frequency scores;

### BRIEF DESCRIPTION OF THE DRAWINGS

FIG. 1 shows an example system for matching a record to one or more record clusters.

FIG. 2 shows an example system for matching a record to one or more record clusters based on token remapping.

FIG. 3 illustrates the configuration of an example token combination rule.

FIG. 4 illustrates the application of the example token combination rule of FIG. 3.

FIG. 5 shows an example process of applying one or more token combination rules to date records.

FIG. 6 shows a screenshot of the configuration of an example token combination rule for date records.

FIG. 7 shows a screenshot of matchcodes generated with the application of the token combination rule shown in FIG. 6 on a date record of “Feb. 1, 2010.”

FIG. 8 shows an example system for matching a record to one or more record clusters based on spellchecking.

FIG. 9 shows an example of record matching using spellchecking.

FIG. 10 shows an example system for matching a record to one or more record clusters based on token remapping and spellchecking.

FIG. 11 is a flow diagram of an example method for calculating matchcode scores for use in matching a record to one or more record clusters.

FIGS. 12-14 illustrate an example of matchcode score calculations.

FIG. 15 shows a computer-implemented environment wherein users can interact with a record matching system hosted on one or more servers through a network.

FIG. 16 shows a record matching system provided on a stand-alone computer for access by a user.

### DETAILED DESCRIPTION

In record matching, the goal is to cluster together records which, despite differences, may refer to the same real-world object. Some or all of the records within a cluster could then theoretically be replaced by a canonical record for that object which the cluster represents.

Matchcodes may be used for record matching. A matchcode is typically the text of the record, transformed by a fixed set of text-manipulating operations in order to sufficiently reduce the input text so that similar records generate the same matchcode. Table 1 shows an example of a 4-record dataset undergoing a single-matchcode generation process. Each of the records contains a personal name, including a first name token (field) and a last name token (field).

TABLE 1
Example of a Single-Matchcode Generation Process

| No. | Record | Matchcode |
|---|---|---|
| 1 | JAMES SCOTT | JAMES SKT |
| 2 | SCOTT JAMES | SCT JMS |
| 3 | SCOTT JAMAS | SCT JMS |
| 4 | SCOTT KAMAS | SCT KMA |

Because records 2 and 3 have the same matchcode, they are therefore matched and can be both assigned to a record cluster. Record 1 does not share the same matchcodes with any other record and is thus considered to not match with any other records. The same is true for record 4.

It is evident from this example that the single-matchcode method has some limitations. For example, while SCOTT JAMAS is a possible customer name, it could also, due to an input error, be a match for SCOTT JAMES or SCOTT KAMAS. Similarly, due to a transposition of tokens (fields) within a record, JAMES SCOTT and SCOTT JAMES might refer to the same person. However, the single-matchcode method generates exactly one matchcode for a record and thus cannot account for the possibility of a single record belonging to multiple record clusters. As disclosed herein, computer-implemented systems and methods are provided for matching a single record to one or more record clusters.

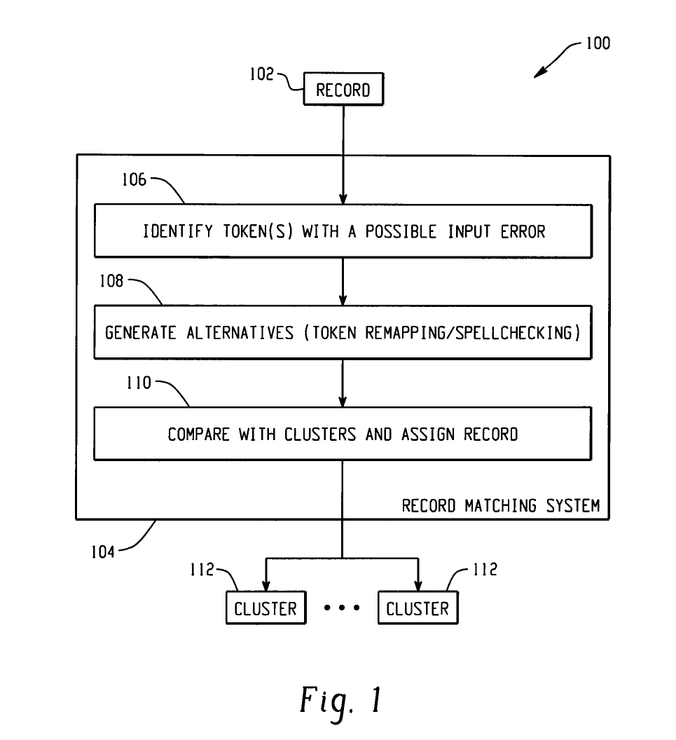

FIG. 1 shows an example system 100 for matching a record to one or more record clusters. The example system 100 includes a record matching system 104 for processing the record 102, including identifying token(s) of the record that may contain a possible input error at step 106. Alternatives of the record may be generated to address the possible input error at step 108. For example, in a personal name record, JAMAS SCOTT, it is possible that the first name token and the last name token are entered in a wrong order. An alternative of the record, SCOTT JAMAS, may be generated at step 108 to address such an input error. The record and the alternative(s) may then be compared with a plurality of record clusters at step 110. If the record or any of its alternatives match one or more record clusters, then the record may be assigned to the one or more record clusters 112. Whether the record or any of its alternatives match one or more record clusters may be determined by different approaches, for instance by using matchcodes that are generated for the record and its alternatives.

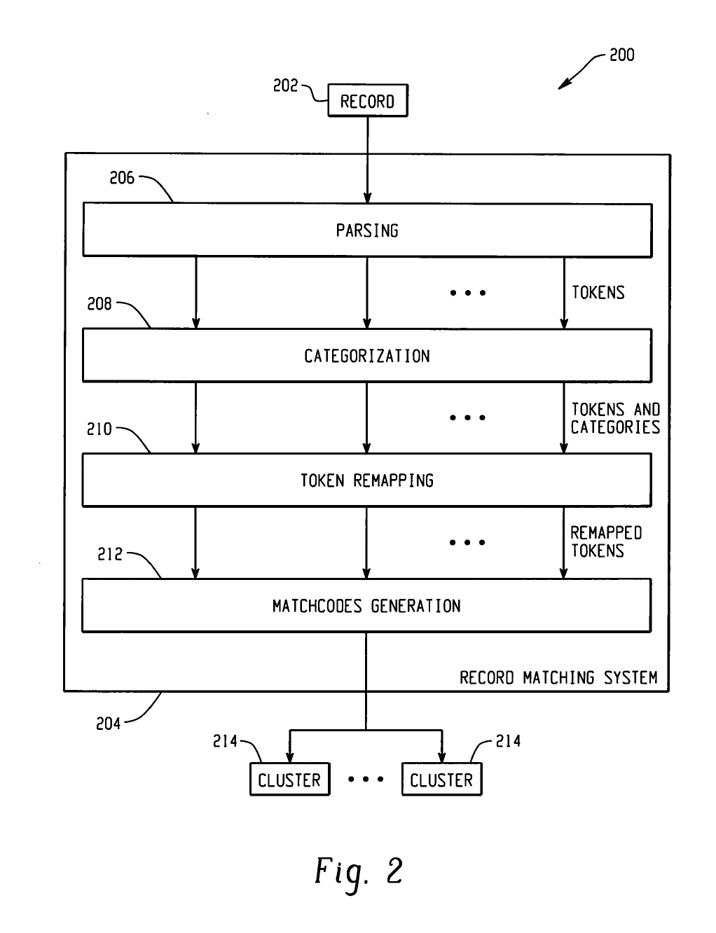

FIG. 2 shows an example system 200 for matching a record to one or more record clusters based on token remapping. The example system 200 includes a record matching system 204 for processing a record 202 based on token remapping to address possible input errors in records.

One type of input error commonly seen in matching is records that have tokens entered in different orders, or with certain tokens omitted (“token-level errors”). Some examples of these errors are shown in Table 2.

TABLE 2
Examples of token-level errors

| | | Example | Example |
|---|---|---|---|
| Type of records | Description | Record 1 | Record 2 |
| Personal names | First and last | James Scott | Scott James |
| | names transposed | | |
| Dates - US vs. | Day and month | 1/2/2010 | 2/1/2010 |
| Euro/Asia formats | transposed | | |
| Address conventions | Fields omitted | The Bell Hotel, | 24 High Street, |
| with redundant | | 24 High Street, | Swindon |
| information | | Old Town, | SN1 3EP |
| | | Swindon | |
| | | SN1 3EP | |

With reference again to FIG. 2, the record 202 is parsed into one or more tokens at step 206, if the record is not already divided into tokens. At step 208, the tokens of the record are assigned to different categories indicating a likelihood of input errors. For example, it is possible that a first name token and a last name token in a personal name record are transposed. A category COULD_BE_LAST may be assigned to the first name token and a category COULD_BE_FIRST may be assigned to the last name token.

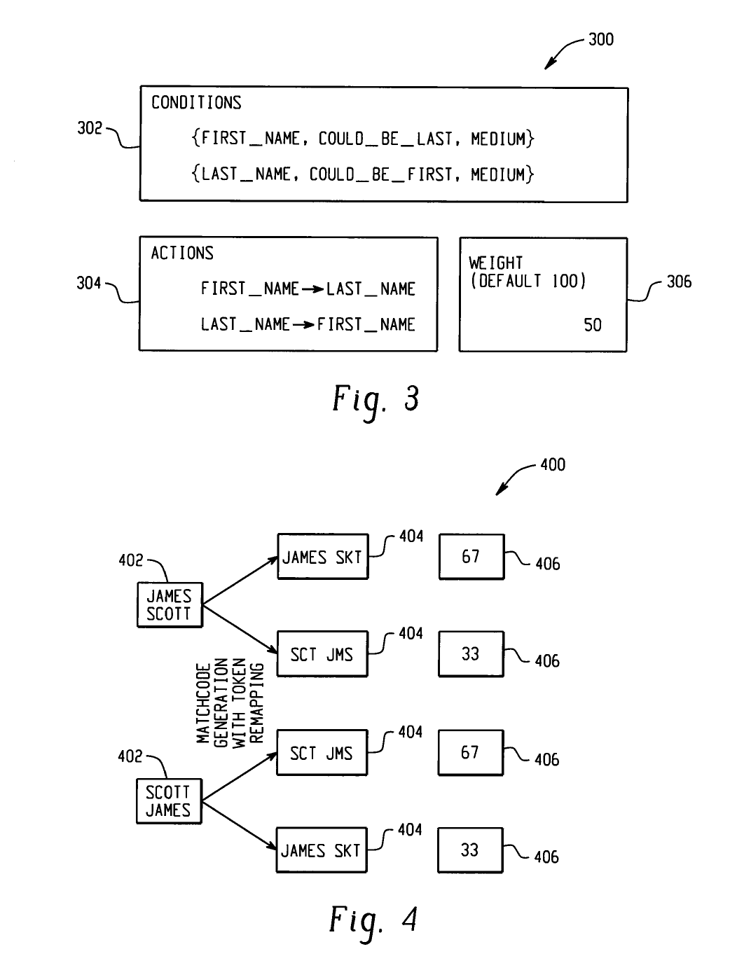

A plurality of different combinations of the tokens are then generated (token remapping) at step 210 to address the possible input errors based on the tokens' assigned categories. One combination of the tokens may keep the original form of the record. Other combinations may be generated based on one or more token combination rules. For example, for a transposition of first name and last name tokens in a personal name record, two combinations of the tokens may be generated. One combination keeps the original personal name in the record. The other combination may be generated based on a token combination rule that causes the first name token and the last name token of the record to be swapped. An example token combination rule is described below with reference to FIG. 3.

With reference again to FIG. 2, matchcodes may be generated at step 212 based on the different combinations of the tokens. For example, a matchcode may be generated for each combination of the tokens. The generated matchcodes may be used to compare with a plurality of record clusters. At step 214, the record may be assigned to every record cluster that matches with one matchcode of the record.

FIG. 3 shows the configuration 300 of an example token combination rule. The example token combination rule has three components: its conditions 302, its actions 304, and its weight 306. A condition is described by a tuple {TOKEN, CATEGORY, MIN_LIKELIHOOD}, which denotes that, in order for this condition to be satisfied, the token with name TOKEN has the category with name CATEGORY assigned to it, with a likelihood greater or equal to MIN_LIKELIHOOD. There is also an optional flag for negation. If the negation flag is specified, the logic is reversed: the token does not have CATEGORY assigned. A rule may have zero or more conditions; all the conditions for a rule may need to be satisfied in order for the rule to be applied.

An action is described by a mapping NOMINAL→REPLACEMENT, which denotes that the token with name NOMINAL is to be replaced by the token with name REPLACEMENT. The empty token (a blank string) is allowed to be specified as the replacement token in any action. The number of actions in a rule is equal to the maximum number of tokens inherent to the type of record under consideration.

The weight of a rule is a single number which reflects the importance of that rule, relative to the other token combination rules and to the “default” no-rule option that accepts the original record without changes.

Based on analysis of the tokens' assigned categories, a token combination rule's conditions are evaluated to determine if the rule is to be applied. Each applied rule results in an input-stage remapping of tokens as described by the rule's actions. A set of K rules may therefore produce a set of up to K matchcodes, in addition to the “default” matchcode produced by applying no rule at all, for a total of between 1 and K+1 matchcodes. The score assigned to each matchcode is computed using the scaled weight of the rule that produces the matchcode.

The example token combination rule shown in FIG. 3 may be used to solve a possible input error of transposed first and last names in a record. The conditions for the rule 302 may be obtained by observing that not all possible names are equally prone to transpositions. Some first names are not very commonly used as last names, and vice versa—so transposition errors may be less likely in these cases. A category is defined for first names called COULD_BE_LAST. A process is applied for determining to what degree a first name “could be” a last name (i.e. its likelihood with respect to the category COULD_BE_LAST). The process could, for example, make use of a dictionary of common first names with numeric or qualitative likelihood values. Any name encountered that is not in this dictionary could be assigned a default (e.g. low) likelihood. Likewise, for last names, a suitable category might be defined as COULD_BE_FIRST and an analogous process for determining a last name token's likelihood with respect to that category may be applied to the last name token of the record. Depending on the outcome of the token-categorization process as shown at step 208 in FIG. 2, the rule may either be applied or not applied for the record.

Finally, the weight for the rule can be obtained either empirically (say, by expert sampling of the input data to determine the frequency of transposition errors), or on the basis of a qualitative judgment of how important such transpositions are. For the example token combination rule shown in FIG. 3, the rule weight is set to 50 with the assumption that the no-rule weight is 100.

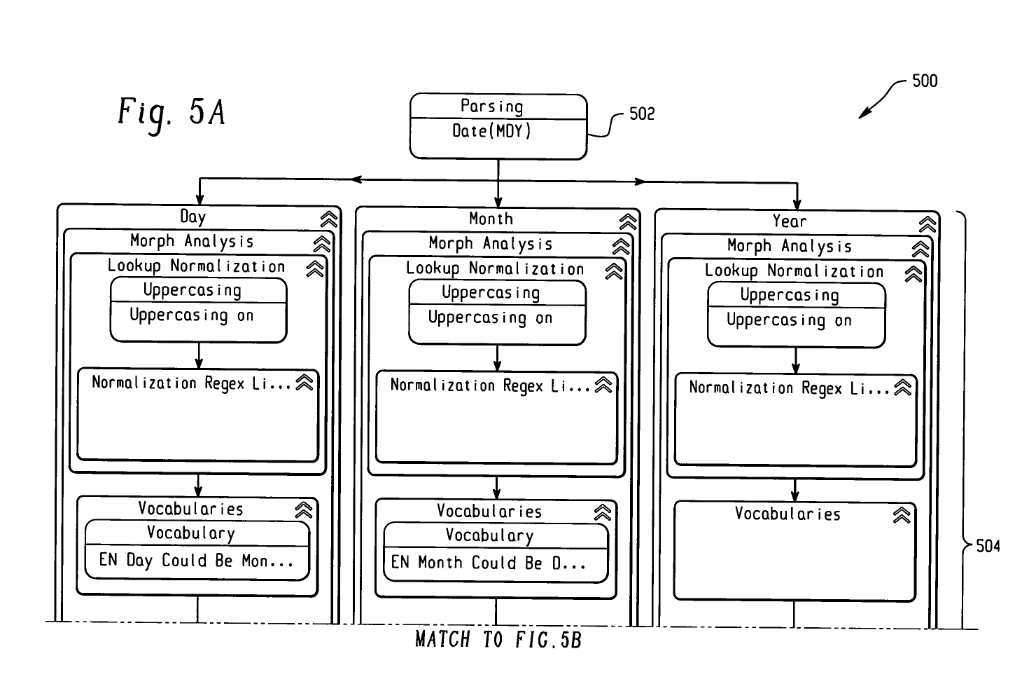

FIG. 4 illustrates the application 400 of the example token combination rule of FIG. 3. Two records of personal names 402 are processed. For each record, applying the example token combination rule yields two combinations. One combination keeps the original form of the record and the other combination is generated by swapping the first name and last name tokens. Based on the combinations of each record, two matchcodes are generated for each record at step 404. At step 406, a score is calculated for each matchcode based on the scaled rule weights.

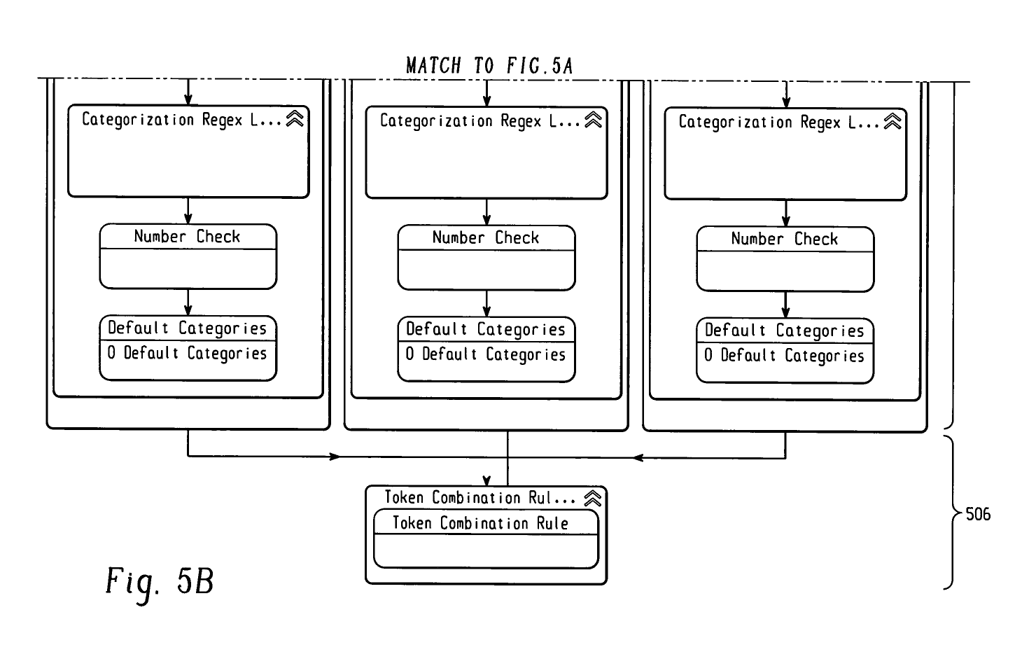

FIGS. 5-7 illustrate an example usage of a token combination rule to address the day/month transposition problem for records of dates. FIG. 5 shows an example process 500 of applying one or more token combination rules to date records. A date record is parsed into the day token, the month token, and the year token at step 502. These tokens are categorized at step 504 with vocabularies used for the day and month tokens. Then at step 506, one or more token combination rules may be applied to the tokens. The different combinations of tokens arising from the application of the token combination rules then pass to further string manipulation blocks (not shown) for generation of matchcodes.

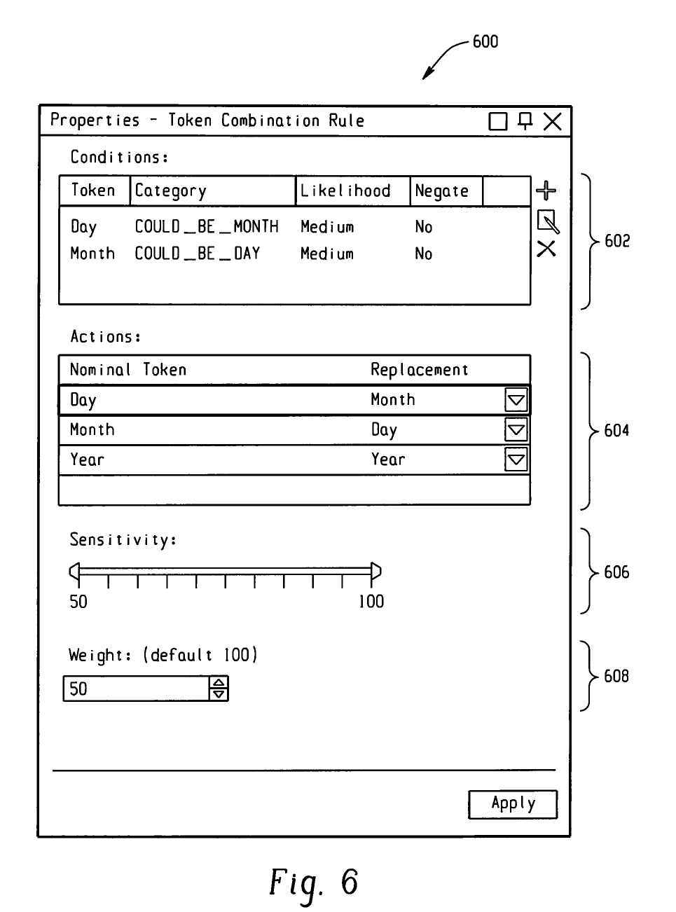

FIG. 6 shows a screen shot 600 of the configuration of an example token combination rule for date records. The rule contains conditions 602, actions 604, a sensitivity range 606, and a rule weight 608. As shown at step 602, the day token of a date record is assigned to a category COULD_BE_MONTH with a likelihood of “medium.” The month token of the date record is assigned to a category COULD_BE_DAY with a likelihood of “medium.” The negate option is specified “no” which indicates that the negation logic is not to be applied. The day and month tokens can be transposed only when both the day and month are given as numbers, and the numbers lie between 1 and 12 (inclusive). These conditions are set up using vocabularies (dictionaries) on the month and day tokens. The actions of the rule 604 are described by swapping the day and month tokens. The sensitivity range 606 controls whether the rule is evaluated for the sensitivity level at which matchcodes are generated. The rule weight 608 is set to 50 with the assumption that the no-rule weight is 100.

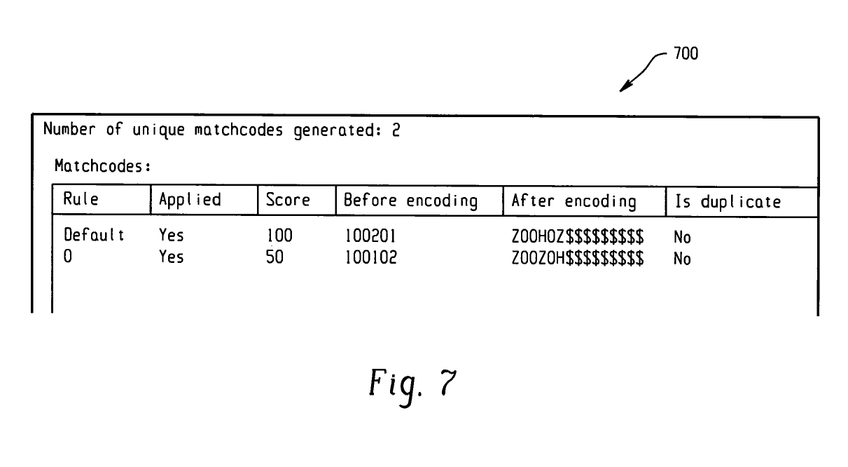

FIG. 7 shows a screenshot 700 of matchcodes generated with the application of the token combination rule shown in FIG. 6 on a date record of “Feb. 1, 2010.” Two matchcodes are generated after the application of the token combination rule and the matchcodes' texts appear in the YYMMDD form.

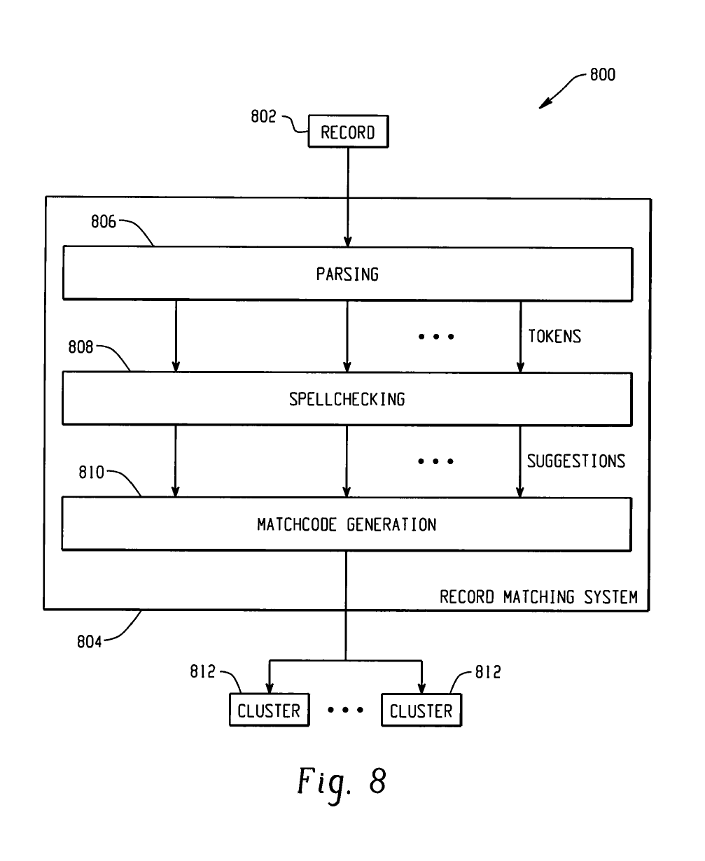

FIG. 8 shows an example system 800 for matching a record to one or more record clusters based on spellchecking. The example system 800 includes a record matching system 804 for processing a record 802 based on spellchecking to address possible spelling errors within tokens. Another source of ambiguity in record matching is spelling errors within a token. The spelling errors may include data entry errors, orthographic variants, homophones, etc. Some examples are shown in Table 3.

TABLE 3
Some examples of spelling errors

| Source of error | Example |
|---|---|
| Mistyping - deletion | George, Gerge |
| Mistyping - insertion | George, Geoorge |
| Mistyping - replacement | George, Geprge |
| Mistyping - transposition | George, Goerge |
| Orthographic variant | Evonne, Yvonne |
| Homophone | Li, Leigh |
| Mis-hearing | Eliza, Elijah |
| Rendering unfamiliar word “as heard” | Phoebe, Feebe |
| Illegible handwriting or poor optical character | Erin, Enn |
| recognition (OCR) | |

The record 802 is parsed into one or more tokens at step 806, if the record is not already divided into tokens. At step 808, spellchecking is applied to the tokens of the record through the usage of spellcheckers. A token may have its own spellchecker. Dictionaries used by a spellchecker may be specialized to the type of data expected for that spellchecker's token. The notion of correctness may be domain-specific.

A spellchecker generates suggestions for a token to address possible spelling errors. For example, for the last name token of a personal name record “SCOTT JAMAS,” a spellchecker may generate three suggestions—JAMAS, JAMES, and KAMAS. The token itself, without correction, is kept as a suggestion. This allows for rare terms not found in the spellchecker's dictionaries. Suggestions are required even for words that appear to be correctly spelled because a correctly-spelled word may be an erroneous version of another intended word. In addition to suggestions, a spellchecker may output a score for each suggestion.

Behavior of a spellchecker can be user-configurable. For example, a user may allow certain types of errors to be corrected, but not others. Numeric costs may be attached to different error categories and thresholds may be applied. These user configurable parameters may model the error-environment, and may affect both the contents and the scores of the suggestions.

Matchcodes may be generated at step 810 based on different combinations of the suggested tokens. For example, three suggestions may be generated for the last name token of a personal name record “SCOTT JAMAS”—JAMAS, JAMES, and KAMAS. Three matchcodes may be generated based on combinations of these suggestions—“SCOTT JAMAS,” “SCOTT JAMES,” and “SCOTT KAMAS.” The generated matchcodes are used to compare with a plurality of record clusters. The record is assigned to every record cluster that matches with one matchcode of the record at step 812.

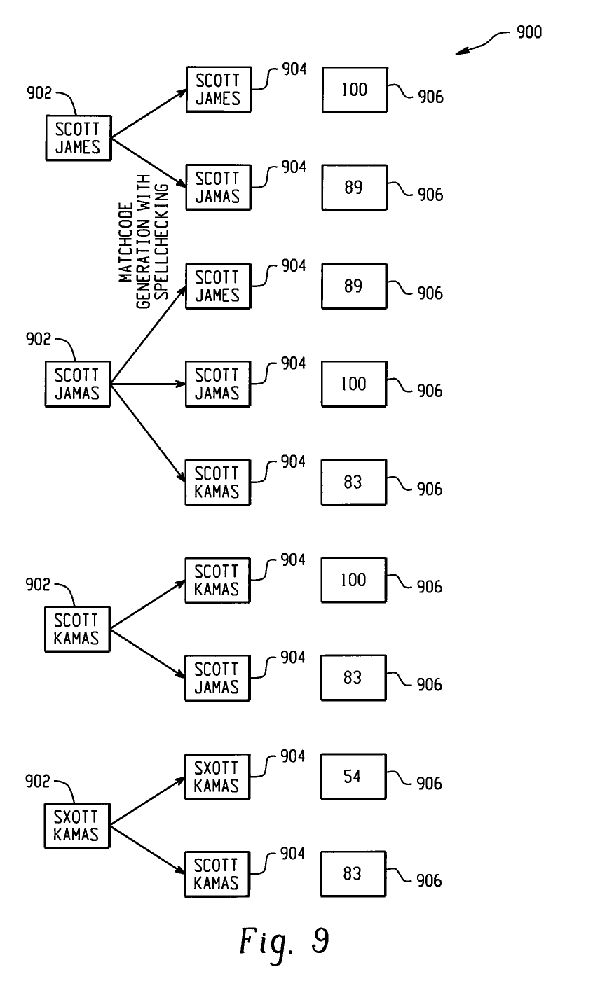

FIG. 9 shows an example 900 of record matching using spellchecking. In the illustrated example 4-record dataset 902 is processed. Matchcodes 904 are generated for the records based on spellchecking. A score 906 is generated for each matchcode based on the user configurable parameters, such as the numerical costs of the errors categories.

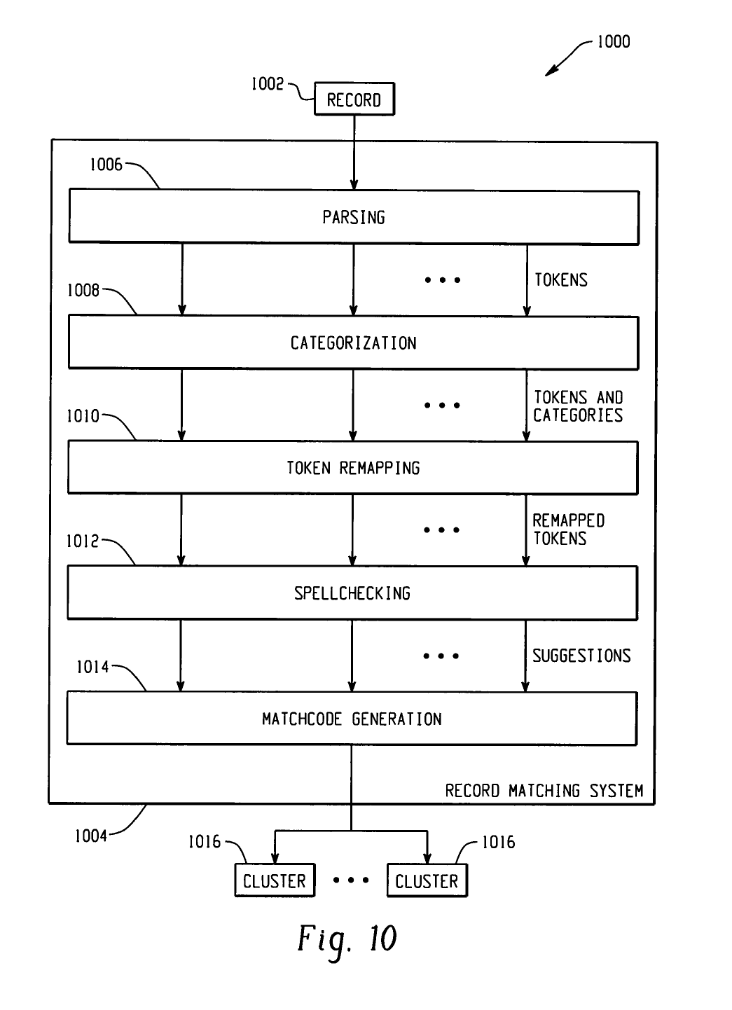

FIG. 10 shows an example system for matching a record to one or more record clusters based on token remapping and spellchecking. The example system 1000 includes a record matching system 1004 for processing a record 1002 based on token remapping and spellchecking to address both the token-level errors and the spelling errors within tokens. The record 1002 is parsed into one or more tokens at step 1006, if the record is not already divided into tokens.

At step 1008, the tokens of the record may be assigned to different categories indicating a likelihood of input errors. A plurality of different combinations of the tokens may be generated (token remapping) at step 1010 to address the possible input errors based on the tokens' assigned categories.

At 1012, spellchecking is carried out on the combinations of remapped tokens. One or more suggestions may be generated for each token to address possible spelling errors. Matchcodes may be generated at step 1014 based on different combinations of the suggestions of the remapped tokens. When there are multiple suggestions for each token under each token combination rule's remapping, the number of possible matchcodes for the record may thus be combinatorial. The generated matchcodes are used to compare with a plurality of record clusters. At step 1016, the record is assigned to every record cluster that matches with one matchcode of the record.

A final score generated for each matchcode may be based on the weights of the token combination rules and the user configurable parameters of the spellcheckers, such as numerical costs of the spelling error categories. The weight assigned to each token combination rule, as well as the allowed errors and the cost of each type of error in the spellchecker, may be assigned or updated in one or a combination of several ways:

(1) by applying ad hoc, qualitative knowledge of the error environment (e.g. from surveys of data entry operators);

(2) by performing a manual exercise in which a subject-area expert tags a data sample, indicating which rules or spelling errors may be applicable to each record, and determining the “correct” clustering (which is used as a target for optimizing the weights and costs); or

(3) via some sort of long-term, automated feedback/optimization process that continuously updates the weights/costs over time, utilizing the user's actual cluster resolutions (i.e. the final decisions on which cluster each record actually does belong to) as the optimization goal.

Scores of matchcodes may be used to aid cluster resolution, i.e. to determine whether some or all of the records in a cluster should be replaced by a canonical record, and what the contents of that canonical record should be. This resolution process may be manual (i.e. by user inspection and editing of the clusters) or automated, perhaps making use of user-configurable cluster resolution rules.

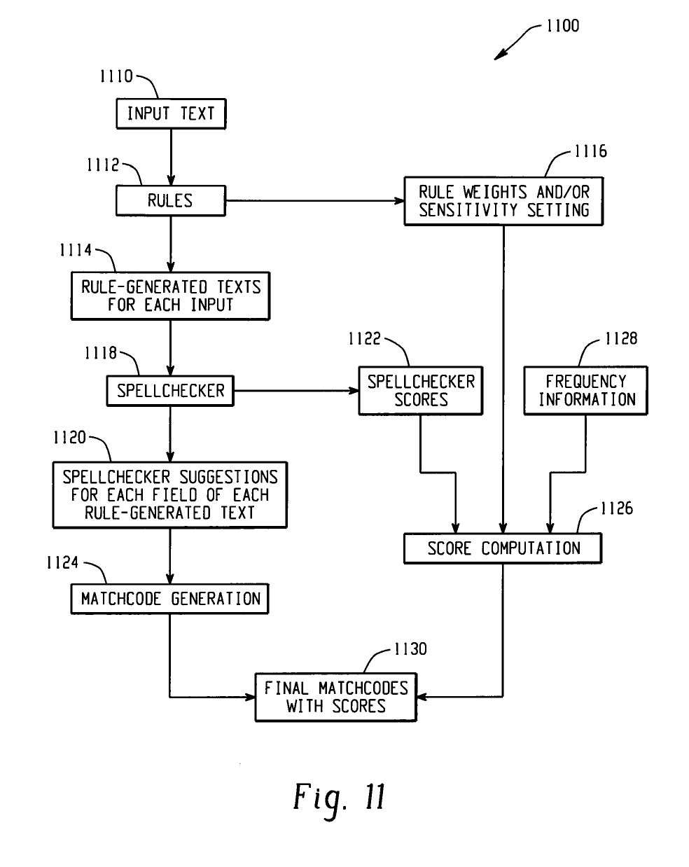

FIG. 11 is a flow diagram of an example method 1100 for calculating matchcode scores for use in matching a record to one or more record clusters based on the combination of token remapping, spellchecking and frequency information. As explained above, a matchcode may be derived based on a fixed token combination rule, a set of spellcheck-type suggestions, or both. In addition, a token combination rule may have a numerical weight assigned to its application based, for example, on the perceived importance of the rule. A spellchecker application may also output a score for each spelling variant based, for example, on how similar the input field is to the spelling variant. The rule weight and the spellchecker scores may be two components of an overall score for a matchcode, as detailed above.

In addition, in generating the overall matchcode score, it may also be desirable to take into account how frequently the text of a particular token appears in the real world in the same context. For instance, although several alternative token remapping and/or spellchecking alternatives might be equally “similar” to the input, the suggestions may not be equally likely because some texts arise more frequently than others in practical usage. For example, consider the input SMITG in a name-matching scenario involving persons in the United States. Two possible spelling variations are SMITH and SMITT. Each of these spelling variations differs from the input by only a single character, and thus from a pure spell-correction viewpoint (assuming that replacement of a character always entails the same cost, regardless of the character involved), these two spelling variants would have the same spellchecker score. But, we know from census data that at least in the United States, SMITH is more common than SMITT. The example method depicted in FIG. 11 provides a way for the overall matchcode score to reflect this frequency information.

In the example depicted in FIG. 11, an record 1110 is received that includes one or more fields (e.g., tokens). For example, a received record could include a first name field (e.g., a first name token) and a last name field (e.g., a last name token.) At 1112, one or more predefined rules are applied to the received record, such as a token combination rule as described above. Each rule 1112 may produce a different rule-generated text 1114 from the received record 1110, where each rule-generated text 1114 includes up to one output text for every field in the received record 1110. For instance, one rule may output the fields of the record as they were received (i.e., the record in its received form), while another rule may transpose one or more fields in the received record (i.e., to generate an alternate form of the received record). For example, if the received record includes the first and last name fields JOHN SMITH, one rule may generate the output JOHN SMITH, and another rule may transpose the first and last name fields to generate the output SMITH JOHN. In addition, each rule may have an associated weight or sensitivity setting 1116, and the weight or sensitivity setting for the rule may then be associated with any output that is generated by the rule.

At 1118, for every field, the set of rule-generated texts 1114 are passed through a spellchecker application which suggests spelling variations 1120 for the texts with associated scores 1122. Then, at 1124, a matchcode generation process is used to further transform and assemble all possible combinations of the texts for each field into matchcodes.

At 1126, the rule weights and/or rule sensitivity settings 1116 and the spellchecker scores 1120 are combined with frequency information 1128 to generate an overall score for each matchcode. The frequency information 1128 may, for example, include a list of terms together with their frequencies. Either absolute or relative frequencies can be used. For example, SMITH might have a frequency of 880.85 per 100,000 individuals in the United States, while SMITT may have a frequency of 0.09 per 100,000 individuals. The score computation 1126 may, for example, normalize raw frequencies by scaling by the sum over all the terms. Some terms may be so infrequent that their normalized frequencies are effectively zero. In addition, terms which are believed to potentially occur but for which information is unavailable can also have their frequencies set to zero.

Frequency information may, for example, be obtained from general reference sources (e.g., census data, for personal names; company directories, for organization names; or address databases, for street names) and stored to a database. In certain embodiments, frequency information could also be obtained during a preprocessing data-mining step by mining the user's own existing data and counting the occurrences of terms contained therein. In this way, the frequency information may be representative of the user's unique data such that the scoring results may more closely reflect that user's own reality. This data-mining step could be repeated at regular intervals to get updated frequency information as the user's data evolves through time. Alternatively, the frequencies could be automatically updated after the matchcodes have been used for deduplication and the user has accepted the surviving record set. The updated frequencies would then be available for use during the next matching run.

The score computation 1126 uses the spell-checker score 1122, the rule weight 1116 (and/or the sensitivity setting at which the matchcode-generation process is being run) and frequency information 1128. The frequency information 1128 utilized by the score computation process 1126 may be the output of a function F that operates upon the normalized frequency f of the term. It is possible that different users may have different views on how important frequency information should be in the computation of the final score. Thus, in certain embodiments, the user may specify a parameter p that controls the function F such that if p is zero, then f makes no contribution at all, while the contribution off increases (not necessarily linearly) asp increases.

An example of how p could affect the scores is shown in Table 4, below. In the example illustrated in Table 4, the left-hand column illustrates results when p is zero and the right-hand column includes results with a non-zero p. As shown, JOHN and JOAN are equally “similar” to the input JOXN (they differ by one character replacement) and so have the same score when p is zero. However, JOHN has a higher frequency than JOAN and so its score is higher when p is nonzero.

TABLE 4

| | | | |
|---|---|---|---|
| JON | 83.33 | JOHN | 83.01 |
| JOHN | 79.17 | JON | 67.27 |
| JOAN | 79.17 | JOAN | 64.97 |
| JOXN | 60.00 | JOXN | 60.00 |

To further illustrate how an overall matchcode score 1130 may be calculated by the score computation process 1126, consider an example in which the dictionary of all allowed suggestions (i.e., spelling variants) for a given field m has N items, each consisting of one or more words. Each of these items is capable of being returned as a suggestion within that field, and each suggestion may arise from a single item or from multiple items in the dictionary. The latter case occurs when the field contains multiple words and the spellchecker is not allowed or not able to provide a single item as a suggestion that corresponds to the whole content of the field. In addition, for the purpose of this illustrative example:
define W(i) as the number of words in item i, where iε[1, N];
define V(i) as the raw frequency count for item i;
define the indicator function

$$I ( i , w ) = \{ \begin{matrix}1 & if W ( i ) = w \\ 0 & otherwise ;\end{matrix}$$

define K+1 as the (fixed) number of frequency bins to be used; and
define W_{F} as the frequency weighting factor chosen by the user.

To avoid large array storage, the following example overall score calculation proceeds in two passes over the dictionary. In the first pass, the quantities needed for normalization are computed, as follows:

S(w)=Σᵢ₌₁^{N}V(i)·I(i,w), the sum of frequencies for items with a given word-count;

M(w)=max_{i, I(i,w)=1}V(i), the maximum frequency for items with a given word-count;

$$B = \frac{{max}_{w} M ( w )}{K} ,$$

the frequency bin size if there are K+1 frequency bins; and

D(w)=B·S(w), the divisor that will normalize a raw frequency.

In the second pass, each of the items is normalized and binned:

$$k ( i ) = ⌊ \frac{V ( i )}{D ( W ( i ) )} ⌋$$

Because the effect of frequency should be greater at larger frequency bins and the maximum effect should be limited by the frequency weighting factor W_{F}, the additive frequency component A(k(i)) of the score for bin k(i), kε[0, K] is therefore:

$$A ( k ( i ) ) = 100 ( {e}^{\frac{l n ( 1 + 0.1 {W}_{F} )}{K} \cdot k ( i )} - 1 )$$

These values are may be precalculated and stored in a lookup table to reduce the amount of calculation required during the processing of suggestions.

Generally, the number of input fields M is greater than one. During suggestion processing, each field generates a number of suggestions with scores derived from the cost of spellchecker operations. For simplicity in the above example, it is assumed that each suggestion consists of a single item. It should be understood, however, that a spelling suggestion often consists of multiple items. For this reason, an additional intra-field combinatorial step, with associated score computation, may be required. Since this is analogous to the computation of T_{C}, details are omitted. The operation-based scores for these suggestions are denoted by r(j,m) where j indexes the suggestions obtained for that field.

If suggestion j for field m is item i in the dictionary, then the frequency component for each suggestion may be obtained from the precalculated table using the bin index, k(i). The frequency-modified score belonging to a single suggestion for a certain field value is calculated by adding this frequency component:

q(j,m)=r(j,m)+A(k(i))

The sum may then be normalized by the maximum possible score for the input field concerned:

$$s ( j , m ) = \frac{q ( j , m )}{{q}_{ma x} ( m )} .$$

It should be noted that qₘₐₓ(m) is the sum of the operation-based score that occurs when the lowest possible cost is expended for each character in the field, and the highest possible frequency component

The output for the entire input string is a combinatorial set of the suggestions for each field. A member C of this set contains, for each m, one suggestion drawn from the set of suggestions for that field. If we let the scores for the contents of C be denoted s_{C}(j,m), then the raw score for C is:

$${T}_{C} = \frac{1}{M} {\sum }_{m = 1}^{M} {s}_{C} ( j , m )$$

When token combination rules are in use, the rule-weighted final score for a certain output C arising from a given rule R with rule weight W_{R} is given by:

$${T}_{CR} = \frac{{W}_{R}}{100} {T}_{C}$$

If the sensitivity level is used as an additional weighting component, then the final score at sensitivity W_{S} is:

$${T}_{CRS} = \frac{{W}_{S}}{100} {T}_{CR}$$

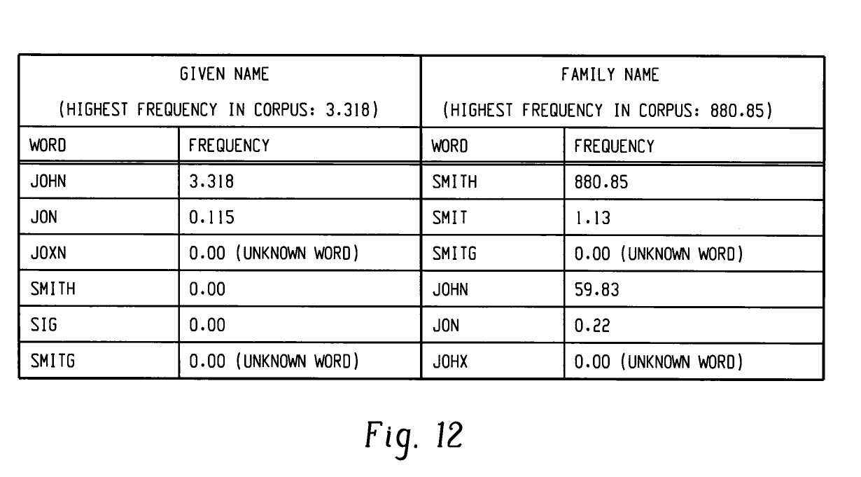

FIGS. 12-14 provide an example to help demonstrate how the above algorithms may be used to calculate overall matchcode scores. The example illustrated in FIGS. 12-14 assumes receipt of the input record JOXN SMITG, which includes a given name field (given name token) and a family name field (family name token). The example also assumes that a token combination rule is applied to the input record with weight=80 that interchanges the given name field and the family name field. The example further assumes that the process is run with a sensitivity weighting of 85. Using these parameters, the variations of the given name field and the family name field, along with the frequency for each of these variations (i.e., for each token), are illustrated in the table shown at FIG. 12. Specifically, the left-hand column in FIG. 12 shows the token variations and associated frequencies for the given name field and the right-hand column shows the token variations and associated frequencies for the family name field.

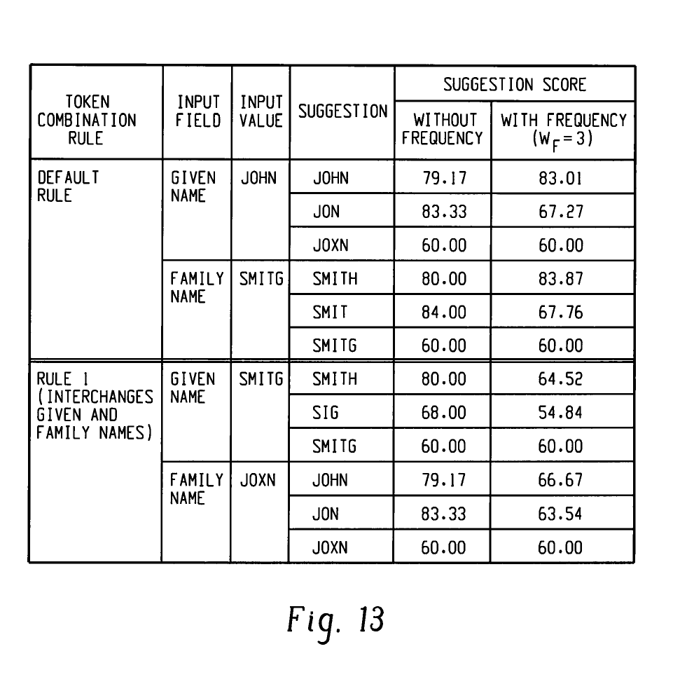

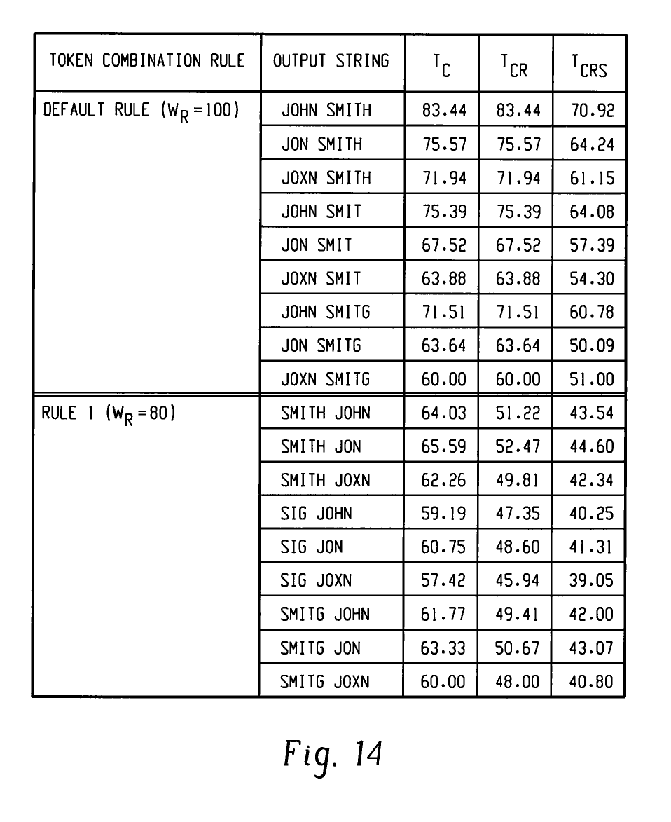

Applying the above algorithms, the resulting suggestion scores for each individual token are illustrated in FIG. 13. The top half of the table in FIG. 13 shows the resultant suggestion scores applying a default token combination rule where the field are not interchanged, and the bottom half of FIG. 13 shows the resultant suggestion scores applying a token combination rule that interchanges the given and family name fields. The two right-most columns in FIG. 13 list the suggestion scores for each token both without considering the frequency information and with the frequency information. Specifically, the left suggestion score column shows the calculated suggestion scores without frequency information and the right suggestion score column shows the calculated suggestions scores with frequency information and assuming selection of a frequency weighting factor of 3. Applying the above algorithms, the overall scores for each string combination, and thus for each matchcode, can be calculated, as shown in FIG. 14.

The top half of FIG. 14 shows the resultant overall scores for the output string combinations applying the default token combination rule where the fields are not interchanged, and the bottom half of FIG. 14 shows the overall scores applying a token combination rule (Rule 1) that interchanges the given and family name fields. As shown, the overall scores are calculated using a rule weighting (W_{R}) of 100 for the default token combination rule and a rule weighting (W_{R}) of 80 for Rule 1. FIG. 14 shows the raw overall score (T_{C}), the rule-weighted overall score (T_{CR}), and the rule-weighted overall score applying sensitivity weighting (T_{CRS}) for each output string combination in the example (assuming a sensitivity weighing of 85). As shown, in each case the output string JOHN SMITH receives the highest overall score in this example.

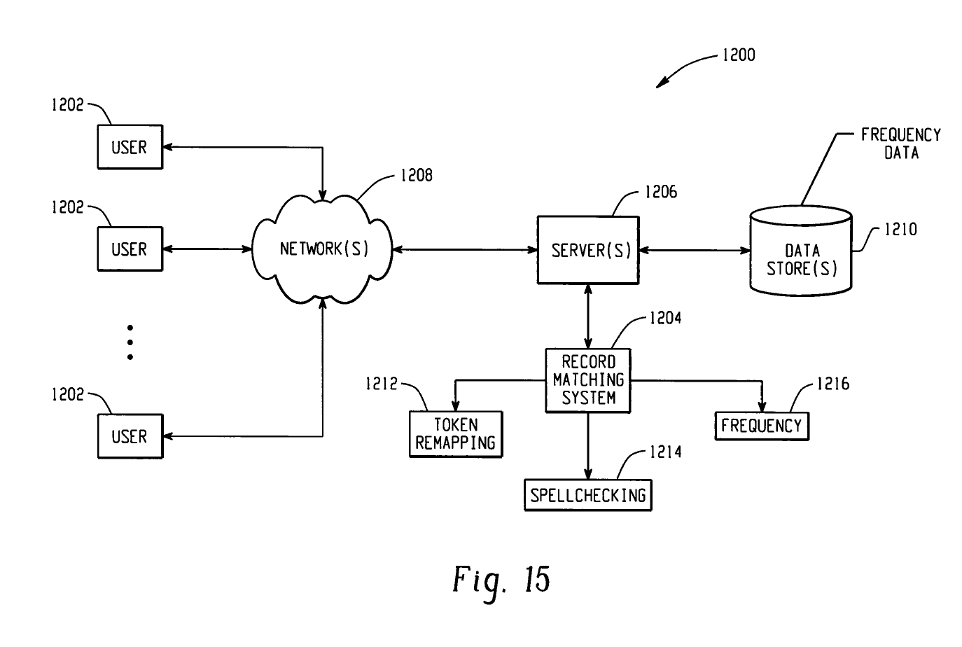

FIG. 15 shows a computer-implemented environment wherein users 1202 can interact with a record matching system 1204 hosted on one or more servers 1206 through a network 1208. The record matching system 1204 can match a record to one or more record clusters. The record matching system 1204 includes a token remapping application 1212, a spellchecking application 1214 and a frequency application 1216, which may be utilized alone or in combination to perform record matching operations, for example using one or more of the methods described above.

The users 1202 can interact with the system 1204 through a number of ways, such as over one or more networks 1208. One or more servers 1206 accessible through the network(s) 1208 can host the record-cluster matching system 1204. The one or more servers 1206 are responsive to one or more data stores 1210 for providing input data to the record matching system 1204. As shown, the one or more data stores 1210 may include frequency data that is utilized by the record matching system 1204 and the frequency application 1216.

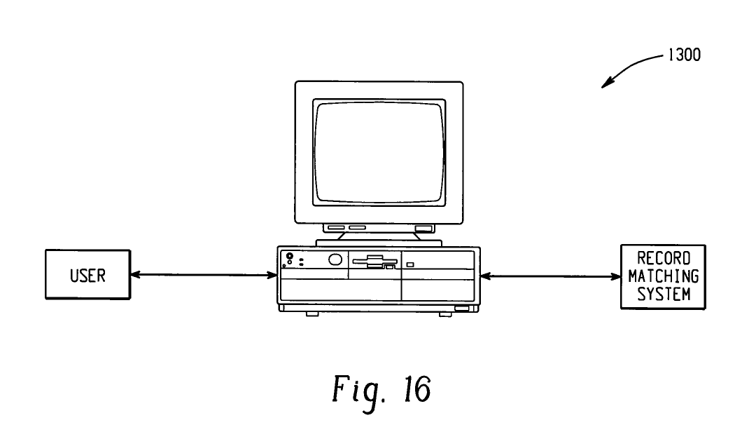

This written description uses examples to disclose the invention, including the best mode, and also to enable a person skilled in the art to make and use the invention. The patentable scope of the invention may include other examples. As an example, a computer-implemented system and method can be configured as described herein to handle the ambiguity inherent in a record matching problem by allowing a record to potentially be assigned to more than one record cluster. As another example, a computer-implemented system and method can be configured to provide a resource-saving approach to matching records in a data set. Such an approach uses computational resources on the order of N, the number of records in the data set, better than the general-purpose clustering methods, which depend on the computation of some concept of distance between records and thus require resources on the order of N². As another example, a computer-implemented system and method can be configured such that a record matching system can be provided on a stand-alone computer for access by a user, such as shown at 1300 in FIG. 16.

Additionally, the methods and systems described herein may be implemented on many different types of processing devices by program code comprising program instructions that are executable by the device processing subsystem. The software program instructions may include source code, object code, machine code, or any other stored data that is operable to cause a processing system to perform the methods and operations described herein. Other implementations may also be used, however, such as firmware or even appropriately designed hardware configured to carry out the methods and systems described herein.

The systems' and methods' data (e.g., associations, mappings, data input, data output, intermediate data results, final data results, etc.) may be stored and implemented in one or more different types of computer-implemented data stores, such as different types of storage devices and programming constructs (e.g., RAM, ROM, Flash memory, flat files, databases, programming data structures, programming variables, IF-THEN (or similar type) statement constructs, etc.). It is noted that data structures describe formats for use in organizing and storing data in databases, programs, memory, or other computer-readable media for use by a computer program.

The systems and methods may be provided on many different types of computer-readable media including computer storage mechanisms (e.g., CD-ROM, diskette, RAM, flash memory, computer's hard drive, etc.) that contain instructions (e.g., software) for use in execution by a processor to perform the methods' operations and implement the systems described herein.

The computer components, software modules, functions, data stores and data structures described herein may be connected directly or indirectly to each other in order to allow the flow of data needed for their operations. It is also noted that a module or processor includes but is not limited to a unit of code that performs a software operation, and can be implemented for example as a subroutine unit of code, or as a software function unit of code, or as an object (as in an object-oriented paradigm), or as an applet, or in a computer script language, or as another type of computer code. The software components and/or functionality may be located on a single computer or distributed across multiple computers depending upon the situation at hand. It should be understood that as used in the description herein and throughout the claims that follow, the meaning of “a,” “an,” and “the” includes plural reference unless the context clearly dictates otherwise. Also, as used in the description herein and throughout the claims that follow, the meaning of “in” includes “in” and “on” unless the context clearly dictates otherwise. Finally, as used in the description herein and throughout the claims that follow, the meanings of “and” and “or” include both the conjunctive and disjunctive and may be used interchangeably unless the context expressly dictates otherwise; the phrase “exclusive or” may be used to indicate situation where only the disjunctive meaning may apply.

It is claimed:

1. A computer-implemented method comprising:
receiving a record that includes a plurality of fields;
applying one or more token combination rules to the record to associate one or more tokens with each of the plurality of fields, wherein each of the one or more tokens includes a text string from one of the plurality of fields of the record;
applying a spellcheck application to each of the tokens to generate one or more alternative tokens for each of the plurality of fields of the record;
generating a score for each token and alternative token in each of the plurality of fields, wherein the score is based at least in part on a frequency score, and wherein each frequency score relates to a frequency of use for the text string included in the token;
generating a plurality of token combinations from the tokens and alternative tokens based on the one or more token combination rules, wherein each of the plurality of token combinations includes one token or alternative token from each of the plurality of fields of the record; and
generating an overall score for each token combination based at least in part on the scores for the tokens or alternative tokens that make up the token combination;
wherein the steps of the method are performed by one or more processors.

2. The method of claim 1, wherein each frequency score relates to a frequency that the text string included in the token is used in association with a particular field type.

3. The method of claim 1, further comprising:
generating a matchcode for each token combination and associating an overall score with each matchcode.

4. The method of claim 3, further comprising:
comparing the matchcodes with a plurality of record clusters to identify one or more records with corresponding matchcodes; and
assigning one or more of the token combinations to a record cluster based on the comparisons.

5. The method of claim 1, wherein the score for each token is based on the frequency score and a spellcheck score generated by the spellcheck application.

6. The method of claim 1, wherein the overall score for each token combination is based in part on a weighting of a token combination rule used to generate the token combination.

7. A system, comprising:
one or more processors;
a computer-readable memory encoded with instructions for commanding the one or more processors to perform steps comprising:
receiving a record that includes a plurality of fields;
applying one or more token combination rules to the record to associate one or more tokens with each of the plurality of fields, wherein each of the one or more tokens includes a text string from one of the plurality of fields of the record;
applying a spellcheck application to each of the tokens to generate one or more alternative tokens for each of the plurality of fields of the record;
generating a score for each token and alternative token in each of the plurality of fields, wherein the score is based at least in part on a frequency score, and wherein each frequency score relates to a frequency of use for the text string included in the token;
generating a plurality of token combinations from the tokens and alternative tokens based on the one or more token combination rules, wherein each of the plurality of token combinations includes one token or alternative token from each of the plurality of fields of the record; and
generating an overall score for each token combination based at least in part on the scores for the tokens or alternative tokens that make up the token combination.

8. The system of claim 7, wherein each frequency score relates to a frequency that the text string included in the token is used in association with a particular field type.

9. The system of claim 7, wherein the steps performed by the one or more processors further comprise:
generating a matchcode for each token combination and associating an overall score with each matchcode.

10. The system of claim 9, wherein the steps performed by the one or more processors further comprise:
comparing the matchcodes with a plurality of record clusters to identify one or more records with corresponding matchcodes; and
assigning one or more of the token combinations to a record cluster based on the comparisons.

11. The system of claim 7, wherein the score for each token is based on the frequency score and a spellcheck score generated by the spellcheck application.

12. The system of claim 7, wherein the overall score for each token combination is based in part on a weighting of a token combination rule used to generate the token combination.

13. A computer-implemented method, comprising:
receiving a record that includes one or more fields, each field having an associated field type;
generating one or more alternative forms of the record based on variations of the one or more fields of the record;
identifying, from stored frequency information, a frequency score for each variation of the one or more fields of the record, wherein each frequency score relates to a frequency of use for a text string included in a field; and
using the frequency scores to generate overall scores for the record and the one or more alternative forms of the record;
wherein the steps of the method are performed by one or more processors.

14. The computer-implemented method of claim 13, wherein the variations of the one or more fields of the record include spelling variations.

15. The computer-implemented method of claim 13, wherein the variations of the one or more fields of the record include variations in the associated field type.

16. The computer-implemented method of claim 13, further comprising:
generating matchcodes for the record and the one or more alternative forms of the record;
comparing the matchcodes with a plurality of record clusters to identify clusters with corresponding matchcodes; and
assigning each of the record and the one or more alternative forms of the record to an identified cluster based on the matchcode comparisons.

17. The computer-implemented method of claim 13, wherein each frequency score relates to a frequency that the text string included in the field is used in association with a particular field type.

18. A computer-implemented method, comprising:
receiving a record that is parsed into a plurality of tokens, each token having an associated token type;
identifying spelling variants for each of the plurality of tokens;
identifying a plurality of alternative tokens using the spelling variants and variations of the associated token type;
identifying, from stored frequency information, a frequency score for each of the plurality of tokens and each of the plurality of alternative tokens, wherein each frequency score relates to a frequency of use for a text string included in the token or alternative token; and
identifying one or more alternative records using one or more combinations of the plurality of alternative tokens;
generating overall scores for the record and the one or more alternative records based at least in part on the frequency scores;
wherein the steps of the method are performed by one or more processors.
